(19) United States
(12) Patent Application Publication
(10) Pub. No.: US 2017/0060268 A1
(43) Pub. Date: Mar. 2, 2017

(54) DEVICE FOR INTEGRATING POSITION, ATTITUDE, AND WIRELESS TRANSMISSION

(71) Applicant: PRINCO CORP., Hsinchu (TW)

(72) Inventors: Chen-Ping Chiu, Hsinchu (TW); Chih-Kuang Yang, Hsinchu (TW); Cheng-Yi Chang, Hsinchu (TW)

(73) Assignee: PRINCO CORP., Hsinchu (TW)

(21) Appl. No.: 15/239,183

(22) Filed: Aug. 17, 2016

(30) Foreign Application Priority Data
Aug. 26, 2015 (TW) 104127936

(51) Int. Cl. G06F 3/0346; G06F 3/038; H04L 29/08

(52) U.S. Cl. CPC G06F 3/0346; H04L 67/12; G06F 3/038; G06F 2203/0384; G06F 3/03543

(57) ABSTRACT

A device for integrating a position, an attitude, and a wireless transmission is disclosed. The device includes an electrical connection substrate, a processor unit, a wireless communication module, and a set of sensors. The wireless communication module is electrically coupled to the processor unit via the electrical connection substrate. The set of sensors is electrically coupled to the processor unit. The processor unit and the wireless communication module are packaged as a monolithic package structure on the electrical connection substrate. The device for integrating the position, the attitude, and the wireless transmission can be manufactured as a miniaturization device. Accordingly, the present invention can be applied to a wearable device and applied to a game in which an absolute positioning is required.

### TECHNICAL FIELD OF THE INVENTION

The present invention relates to a somatosensory field, and more particularly, to a device for integrating a position, an attitude, and a wireless transmission.

### BACKGROUND OF THE INVENTION

A three-dimensional (3D) mouse can be utilized as a general mouse and can have 3D control ability.

A conventional 3D mouse is operated by a palm of a user's hand. Accordingly, the conventional 3D mouse has a particular size. That is, the conventional 3D mouse cannot be too small. Furthermore, the conventional 3D mouse only can be utilized in conjunction with a computer. The conventional 3D mouse cannot be utilized in conjunction with any other device (such as a wearable device), such that applications of the conventional 3D mouse are limited.

Consequently, there is a need to solve the above-mentioned problems that the conventional 3D mouse cannot be too small and the applications thereof are limited in the prior art.

### SUMMARY OF THE INVENTION

An objective of the present invention is to provide a device for integrating a position, an attitude, and a wireless transmission which can solve the above-mentioned problems that the conventional 3D mouse cannot be too small and the applications thereof are limited in the prior art.

The device for integrating the position, the attitude, and the wireless transmission of the present invention comprises an electrical connection substrate, a processor unit, a wireless communication module, and a set of sensors. The wireless communication module is electrically coupled to the processor unit via the electrical connection substrate. The sensors are electrically coupled to the processor unit and comprise a group of accelerometer sensors, a group of angular velocity sensors, and a group of magnetic sensors. The accelerometer sensors are utilized for sensing acceleration values of at least three directions. The angular velocity sensors are utilized for sensing angular velocity values of the at least three directions. The magnetic sensors are utilized for sensing magnetic values of the at least three directions. The processor unit receives the acceleration values of the accelerometer sensors, the angular velocity values of the angular velocity sensors, and the magnetic values of the magnetic sensors and calculates a position and an attitude value in a space according to the acceleration values of the accelerometer sensors, the angular velocity values of the angular velocity sensors, and the magnetic values of the magnetic sensors. The processor unit and the wireless communication module are packaged as a monolithic package structure on the electrical connection substrate.

The device for integrating the position, the attitude, and the wireless transmission of the present invention can be manufactured as a miniaturization device, and thus it can be applied to a game in which an absolute position is required.

### BRIEF DESCRIPTION OF THE DRAWINGS

FIG. 1 shows a device for integrating a position, an attitude, and a wireless transmission in accordance with a first embodiment of the present invention.

FIG. 2 shows a calculation process of a 6-axis inertial sensor.

FIG. 3 shows a calculation process of a 9-axis inertial sensor in the present invention.

FIG. 4 shows a calculation process of a synthesis algorithm of a proportional-integral controller.

FIG. 5 shows a device for integrating a position, an attitude, and a wireless transmission in accordance with a second embodiment of the present invention.

FIG. 6 shows a device for integrating a position, an attitude, and a wireless transmission in accordance with a third embodiment of the present invention.

FIG. 7 shows a device for integrating a position, an attitude, and a wireless transmission in accordance with a fourth embodiment of the present invention.

FIG. 8 shows a device for integrating a position, an attitude, and a wireless transmission in accordance with a fifth embodiment of the present invention.

### DETAILED DESCRIPTION OF THE INVENTION

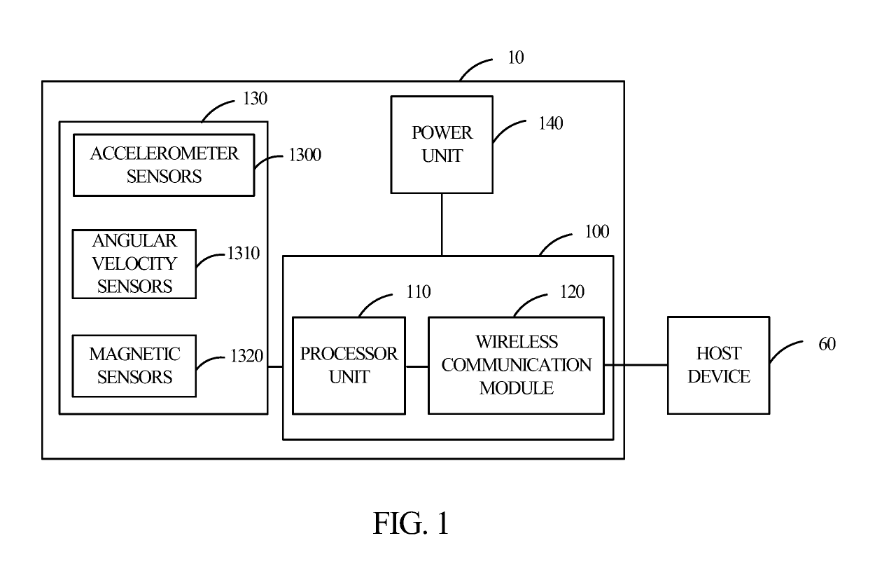

Please refer to FIG. 1. FIG. 1 shows a device 10 for integrating a position, an attitude, and a wireless transmission in accordance with a first embodiment of the present invention.

In the present embodiment, the device 10 for integrating the position, the attitude, and the wireless transmission comprises an electrical connection substrate 100, a processor unit 110, a wireless communication module 120, and a set of sensors 130. The processor unit 110 is electrically coupled to the electrical connection substrate 100. The wireless communication module 120 is electrically coupled to the processor unit 110 via the electrical connection substrate 100. The sensors 130 are electrically coupled to the processor unit 110 via the electrical connection substrate 100. The processor unit 100 can be an Application Processor (AP).

The processor unit 110 and the wireless communication module 120 are packaged on the electrical connection substrate 100. One feature of the present invention is that the processor unit 110 and the wireless communication module 120 are packaged as a monolithic package structure, e.g. a System in Package (SiP), on the electrical connection substrate 100. In a preferred embodiment, the electrical connection substrate 100 is a flexible multi-layer substrate. A manufacturing method of the flexible multi-layer substrate, for example, is to alternately form a plurality of metal layers and a plurality of dielectric layers on a temporary carrier. The metal layers can be formed by a metal lift off process. The dielectric layers can be formed with polyimide by a spin coating method. The metal layers and the dielectric layers together form the flexible multi-layer substrate. Finally, the formed flexible multi-layer substrate is separated from the temporary carrier. A thickness of the electrical connection substrate 100 (i.e. the flexible multi-layer substrate) of the present invention is smaller than 100 micrometers (μm). A thickness of a single layer of the electrical connection substrate 100 can be smaller than 20 μm and even smaller than 10 μm, and all of the dielectric layers are formed by the same material. As a result, the stress consistency among respective layers of the electrical connection substrate 100 is well, and the issue that warpage of the electrical connection substrate 100 happens after being parted from the electrical connection substrate 100 can be better prevented.

In the present embodiment, the device 10 for integrating the position, the attitude, and the wireless transmission further comprises a power unit 140 electrically coupled to the electrical connection substrate 100. The power unit 140 is utilized for providing required power for the processor unit 110 and the wireless communication module 120.

In the device 10 for integrating the position, the attitude, and the wireless transmission, the processor unit 110 and the wireless communication module 120 are packaged as a monolithic package structure on the electrical connection substrate 100. Accordingly, the device 10 for integrating the position, the attitude, and the wireless transmission can be manufactured as a miniaturization device or a wearable device, for example, a wrist device, a band device, or a ring device. Furthermore, since the device 10 for integrating the position, the attitude, and the wireless transmission is modularized to a miniaturization device, the device 10 for integrating the position, the attitude, and the wireless transmission can be assembled to a common mouse, so that the common mouse can be utilized as a 3D mouse.

The sensors 130 at least comprise a group of accelerometer sensors (G-sensors) 1300, a group of angular velocity sensors (gyro sensors) 1310, and a group of magnetic sensors (magnetometers) 1320. The accelerometer sensors 1300 are utilized for sensing acceleration values of at least three directions. The angular velocity sensors 1310 are utilized for sensing angular velocity values of the at least three directions. The magnetic sensors 1320 are utilized for sensing magnetic values of the at least three directions. The processor unit 110 receives the acceleration values of the accelerometer sensors 1300, the angular velocity values of the angular velocity sensors 1310, and the magnetic values of the magnetic sensors 1320 and calculates a position and an attitude value in a space according to the acceleration values of the accelerometer sensors 1300, the angular velocity values of the angular velocity sensors 1310, and the magnetic values of the magnetic sensors 1320. The wireless communication module 120 transmits the position and the attitude value in the space which are calculated by the processor unit 110 to a host device. If the device 10 for integrating the position, the attitude, and the wireless transmission utilizes a 6-axis inertial sensor (including a 3-axis gyro and a 3-axis accelerometer), there is a disadvantage that a direction angle diverges with time. When the sensors 130 include the magnetic sensors (magnetometers) 1320, the disadvantage of the 6-axis inertial sensor can be solved.

The 6-axis inertial sensor includes a 3-axis gyro and a 3-axis accelerometer. Then, a motional attitude angle and an acceleration signal of a device are outputted after calculations. In contrast, the sensors 130 of the present invention constitute a 9-axis inertial sensor. The magnetic sensors 1320 of the sensors 130 can increase the output accuracy (the attitude angle and the acceleration), and thus the disadvantage that the direction angle of the 6-axis inertial sensor can be eliminated.

To understand the advantages of the 9-axis inertial sensor utilized in the present invention, the principles of the 6-axis inertial sensor and the 9-axis inertial sensor will be described as follows.

In the earth frame (e-frame), an origin is usually set in the surface of the earth. The x axis is toward the north. The y axis is toward the east. The z axis is toward the center of the earth. The earth frame (e-frame) is a coordinate space in which a kinetic characteristic of a device is observed by a user in practice. The following observation vectors will be denoted by “e” at top right corners of the observation vectors. In the sensor frame (s-frame), an origin is usually set in the center of a device. The x axis, the y axis, and the z axis are respectively aligned with axes of a direction angle ψ, an elevation angle θ, and a rolling angle φ of a device. The sensor frame (s-frame) is a coordinate space in which a kinetic characteristic of a device is observed by a sensor in practice. The following measurement vectors will be denoted by “s” at top right corners of the measurement vectors.

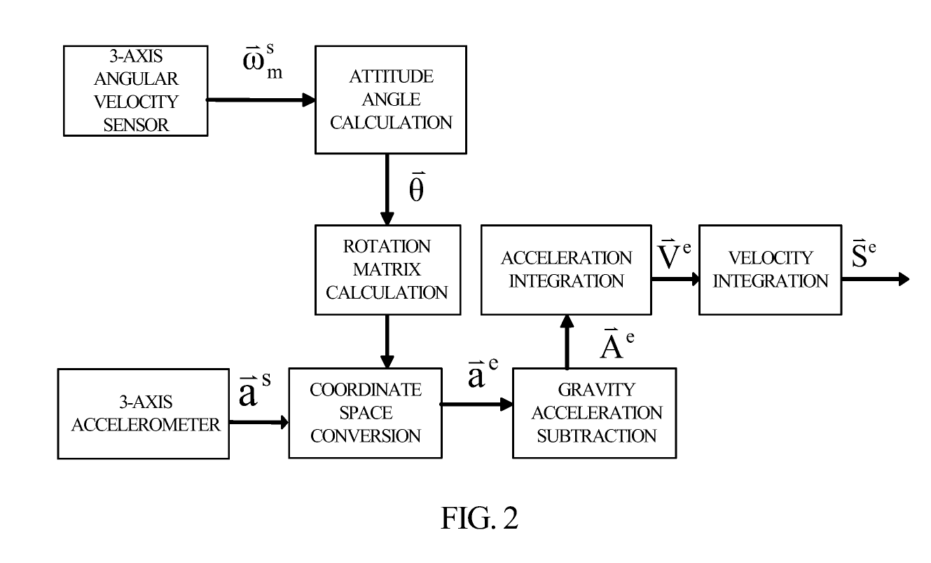

Please refer to FIG. 2. FIG. 2 shows a calculation process of a 6-axis inertial sensor. The inertial sensor comprises a 3-axis gyro and a 3-axis accelerometer. Firstly, the 3-axis gyro acquires information of an instant angular velocity

$$\text{?} \\ \text{?} \text{indicates text missing or illegible when filed}$$

of a device with respect to the sensor frame (s-frame). An attitude angle

$$\text{?} \\ \text{?} \text{indicates text missing or illegible when filed}$$

(ψ, θ, φ) of the device with respect to the earth is acquired by integration and accumulation. A rotation matrix Rₑ₂ₛ which converts from the sensor frame (s-frame) to the earth frame (s-frame) can be acquired by the following formula 1:

$${R}_{e 2 s} ( ψ , θ , φ ) = [ \begin{matrix}cos ( ψ ) cos ( θ ) & sin ( ψ ) cos ( θ ) & - sin ( θ ) \\ \begin{matrix}cos ( ψ ) sin ( θ ) sin ( φ ) - \\ sin ( ψ ) cos ( φ )\end{matrix} & \begin{matrix}sin ( ψ ) sin ( θ ) sin ( φ ) + \\ cos ( ψ ) cos ( φ )\end{matrix} & cos ( θ ) sin ( φ ) \\ \begin{matrix}cos ( ψ ) sin ( θ ) cos ( φ ) + \\ sin ( ψ ) sin ( φ )\end{matrix} & \begin{matrix}sin ( ψ ) sin ( θ ) cos ( φ ) - \\ cos ( ψ ) sin ( φ )\end{matrix} & cos ( θ ) cos ( φ )\end{matrix} ] \qquad Formula 1$$

After the rotation matrix Rₑ₂ₛ is acquired, the information

$${a}^{{ϖ}_{s}}$$

measured by the 3-axis accelerometer is converted to the acceleration information

$${a}^{{ϖ}_{e}}$$

with respect to the earth by the following formula 2:

$${a}^{{ϖ}_{e}} = {R}_{e 2 s} \times {a}^{{ϖ}_{s}} ⇒ [ \begin{matrix}{a}_{x}^{e} \\ {a}_{y}^{e} \\ {a}_{z}^{e}\end{matrix} ] = {R}_{e 2 s} ( \begin{matrix}ψ \\ φ \\ ϕ\end{matrix} ) \times [ \begin{matrix}{a}_{x}^{s} \\ {a}_{y}^{s} \\ {a}_{z}^{s}\end{matrix} ] \qquad Formula 2$$

The acceleration information

$${a}^{{ϖ}_{e}}$$

contains gravity information. Accordingly, a real acceleration measurement of the device is acquired by subtracting the gravity information from the acceleration information

$${a}^{{ϖ}_{e}} .$$

Finally. the velocity information

$$\text{?} \\ \text{?} \text{indicates text missing or illegible when filed}$$

and the displacement information

$$\text{?} \\ \text{?} \text{indicates text missing or illegible when filed}$$

are acquired by integration with time and accumulation.

It is noted that the information of the annular velocity

$${\text{?}}_{m} \\ \text{?} \text{indicates text missing or illegible when filed}$$

has an error amount, that is,

$${\text{?}}_{m} = {\text{?}}_{real} + {\text{?}}_{error} . \\ \text{?} \text{indicates text missing or illegible when filed}$$

The error amount is a key to determine performance of a system and to determine whether the inertial sensor is valuable. An error of the attitude angle

$$( {θ}_{error} = \int {{ω}^{ϖ}}_{error} d t )$$

is accumulated with time. Currently, microelectromechanical systems (MEMS) gyros on the market are suitable to be applied to general 3C consumer products because prices thereof are low. An error of accuracy is about several degrees per hour to 1 degree per second.

However, when an MEMS gyro with an error of accuracy of 1 degree per second is utilized as the 6-axis inertial sensor of the present invention, the 6-axis inertial sensor responses that the device is rotated 60 degrees per minute in a static condition. When an orientation of the device or information of a displacement is acquired by utilizing the information from the 6-axis inertial sensor, it is not valuable.

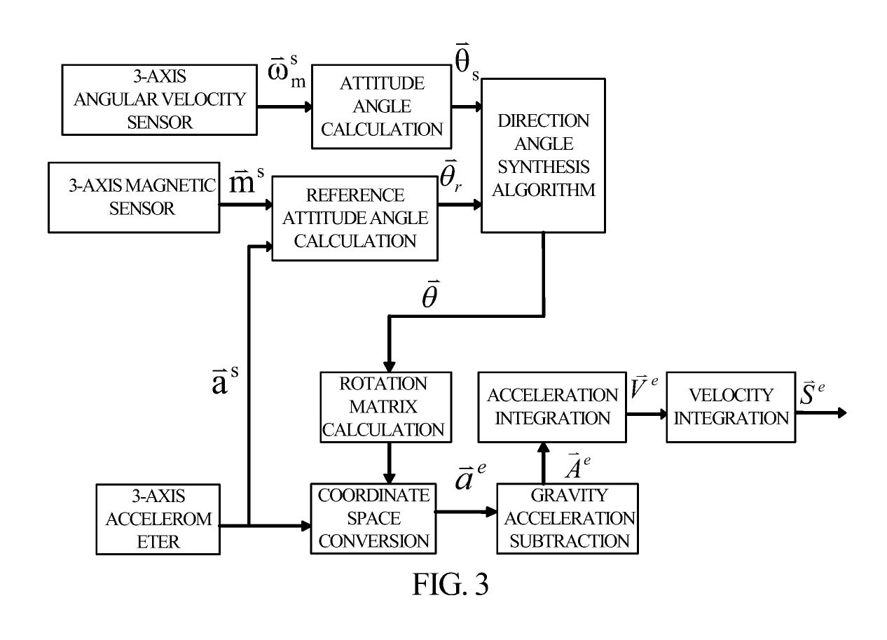

Please refer to FIG. 3. FIG. 3 shows a calculation process of a 9-axis inertial sensor (i.e. the sensors 130 in FIG. 1). The 9-axis inertial sensor comprises a 3-axis gyro, a 3-axis accelerometer, and a 3-axis magnetometer. A main difference between the 6-axis inertial sensor and the 9-axis inertial sensor is that the attitude angle

$${θ}^{ω}$$

is not estimated from the information

$${{θ}^{ω}}_{s}$$

which is acquired after the integration of the 3-axis gyro. The attitude angle

$${θ}^{ω}$$

is estimated by synthesizing the attitude angle

$${θ}^{ω}$$

and a reference attitude angle

$${{θ}^{ω}}_{r} .$$

The reference attitude angle

$${{θ}^{ω}}_{r}$$

can be calculated from the sensed geomagnetic vector, the gravity vector, and formulas 3-5:

φᵣ=tan⁻¹(a_{y}^{s}/aₓ^{s}^{²}+a_{z}^{s}^{²}) Formula 3

θᵣ=tan⁻¹(aₓ^{s}/a_{y}^{s}^{²}+a_{z}^{s}^{²}) Formula 4

ψᵣ=a tan 2(m_{y}^{e},mₓ^{e}) Formula 5

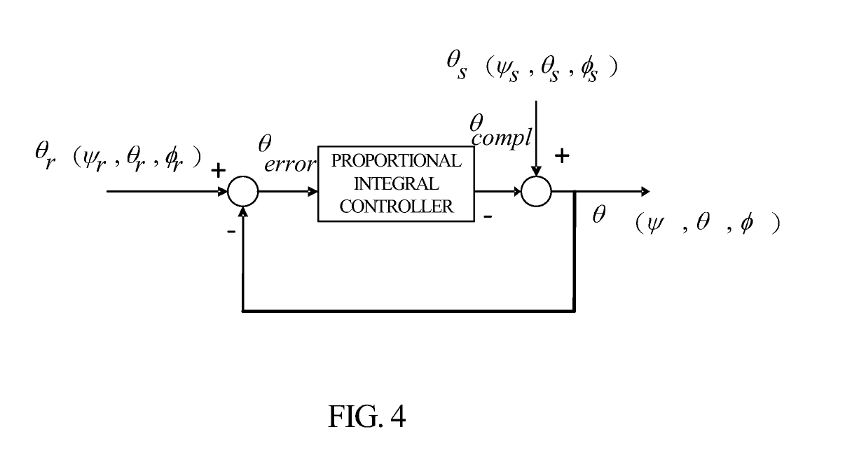

Performance of the 9-axis inertial sensor is determined from a measurement accuracy of the 9-axis inertial sensor and an algorithm for synthesizing directional angles. Currently, the algorithm, such as a proportional integral based (PI based) algorithm, a Kalman filter based algorithm, or a gradient descent based algorithm, can effectively restrain an error of the above-mentioned attitude angle. Taking a PI controller synthesis algorithm for example, as shown in FIG. 4, the attitude angle

$${θ}^{ω}$$

is served as an output of a feedback control system. The reference attitude angle

$${{θ}^{ω}}_{r}$$

is served as an input (i.e. a tracking target of the feedback control system) of the feedback control system. The error of the attitude angle θₑᵣᵣₒᵣ is acquired by subtracting the attitude angle

$${θ}^{ω}$$

from the reference attitude angle

$${{θ}^{ω}}_{r} .$$

Then, a result is acquired from a formula 6 after the error of the attitude angle θₑᵣᵣₒᵣ passes through the PI controller. The result compensates the information

$${{θ}^{ω}}_{s}$$

which is acquired after the integration of the 3-axis gyro, and the modified attitude angle

$${θ}^{ω}$$

is acquired. In the PI controller synthesis algorithm, the estimation of the attitude angle

$${θ}^{ω}$$

can immediately responses a change of the 3-axis gyro when the device moves. In a static situation, the input reference attitude angle

$${{θ}^{ω}}_{r}$$

can be completely locked. Accordingly, the position and the attitude can be accurately acquired only when the 9-axis inertial sensor is utilized in the present invention.

$${{θ}^{ω}}_{compl} = {K}_{P} {{θ}^{ω}}_{error} + {K}_{I} \int {{θ}^{ω}}_{error} d t \qquad Formula 6$$

The present invention comprises the processor unit 110, the sensors 130 (including 1300, 1310, and 1320), the wireless communication module 120, the power unit 140, a required clock oscillator, and passive components. When the processor unit 110, the sensors 130 (including 1300, 1310, and 1320), the wireless communication module 120, the power unit 140, the required clock oscillator, and the passive components are assembled in a printed circuit board (PCB), the area of the device 10 for integrating the position, the attitude is large and ranged about 10-20 square centimeters. In the present invention, the processor unit 110, the sensors 130 (including 1300, 1310, and 1320), the wireless communication module 120, the power unit 140, the required clock oscillator, and the passive components are packaged in a monolithic package structure by utilizing a high density multi-layer flexible substrate (i.e. the electrical connection substrate 100). The monolithic package structure can be miniaturized. Furthermore, another advantage of the present invention is that the sensors 130 (including 1300, 1310, and 1320) are packaged in a small package body. Accordingly, geometric distances of the sensors 130 are close and ranged about 1 square centimeter. The sensors are substantially regarded as in the same point in the space, and thus the position information of each of the sensors 130 does not have displacement error.

The device 10 for integrating the position, the attitude, and the wireless transmission is electrically coupled to the host device 60. The host device 60 may comprise but is not limited to a desktop computer, a notebook, a set-top box, or a mobile terminal. The sensors 130 transmit the sensed values to the processor unit 110. The processor unit 110 calculates the position and the attitude value according to the sensed values and transmits the position and the attitude value to the host device 60. The host device 60 can have various applications according to the position and the attitude value. For example, the device 10 for integrating the position, the attitude, and the wireless transmission may be utilized as a 3D mouse. Alternatively, the device 10 for integrating the position, the attitude, and the wireless transmission may be utilized together with a game which is shown by a screen (not shown) of the host device 60. It is noted that “electrically coupled” in the present invention can be electrically coupled via wired signals or electrically coupled via wireless signals.

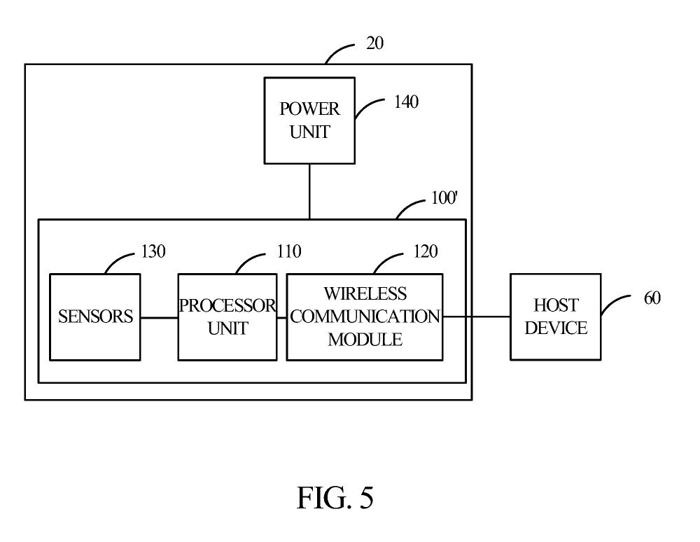

Please refer to FIG. 5. FIG. 5 shows a device 20 for integrating a position, an attitude, and a wireless transmission in accordance with a second embodiment of the present invention.

A difference between the present embodiment and the first embodiment is that the processor unit 110, the wireless communication module 120, and the sensors are packaged as a monolithic package structure on an electrical connection substrate 100′ in the device 20 for integrating the position, the attitude, and the wireless transmission of the present embodiment. In the present embodiment, since the processor unit 110, the wireless communication module 120, and the sensors are packaged as the monolithic package structure, the objective of miniaturization can be achieved. The descriptions with respect to the device 20 for integrating the position, the attitude, and the wireless transmission of the present embodiment can refer to those of the first embodiment and are not repeated herein.

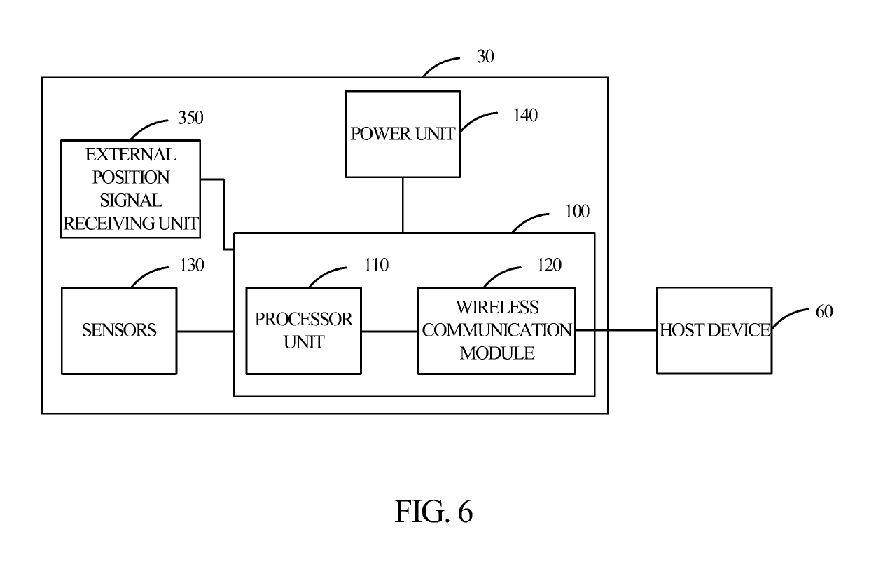

Please refer to FIG. 6. FIG. 6 shows a device 30 for integrating a position, an attitude, and a wireless transmission in accordance with a third embodiment of the present invention.

A difference between the present embodiment and the first embodiment is that the device 30 for integrating the position, the attitude, and the wireless transmission of the present embodiment further comprises an external position signal receiving unit 350. The external position signal receiving unit 350, for example, is a global positioning system (GPS). The external position signal receiving unit 350 is electrically coupled to the processor unit 110 for positioning the device 30 for integrating the position, the attitude, and the wireless transmission. The descriptions with respect to the device 30 for integrating the position, the attitude, and the wireless transmission of the present embodiment can refer to those of the first embodiment and are not repeated herein.

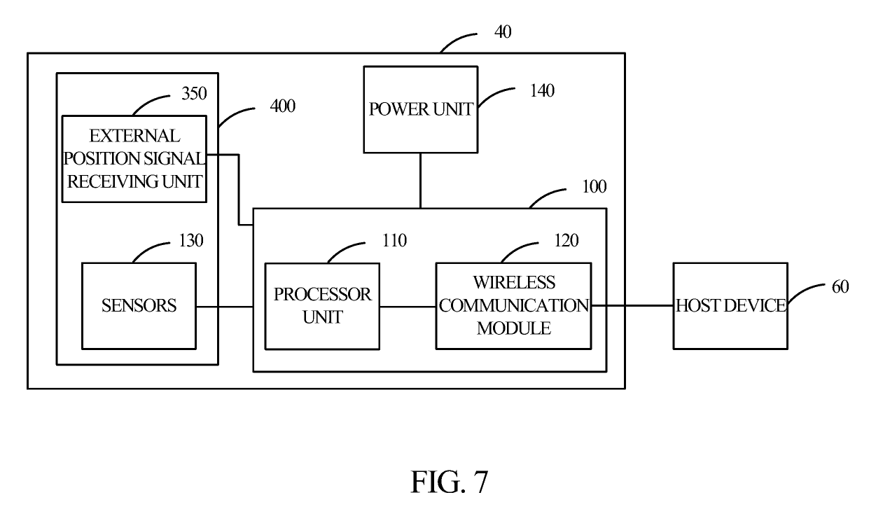

Please refer to FIG. 7. FIG. 7 shows a device 40 for integrating a position, an attitude, and a wireless transmission in accordance with a fourth embodiment of the present invention.

A difference between the present embodiment and the first embodiment is that the sensors 130 and the external position signal receiving unit 350 are packaged as a monolithic package structure on an electrical connection substrate 400 in the device 40 for integrating the position, the attitude, and the wireless transmission of the present embodiment. That is, the sensors 130 and the external position signal receiving unit 350 are electrically coupled to the monolithic package structure which packages the processor unit 110 and the wireless communication module 120 via the electrical connection substrate 400. In the present embodiment, since the sensors 130 and the external position signal receiving unit 350 are packaged as the monolithic package structure, the objective of miniaturization can be further achieved. The descriptions with respect to the device 40 for integrating the position, the attitude, and the wireless transmission of the present embodiment can refer to those of the first embodiment to the third embodiment and are not repeated herein.

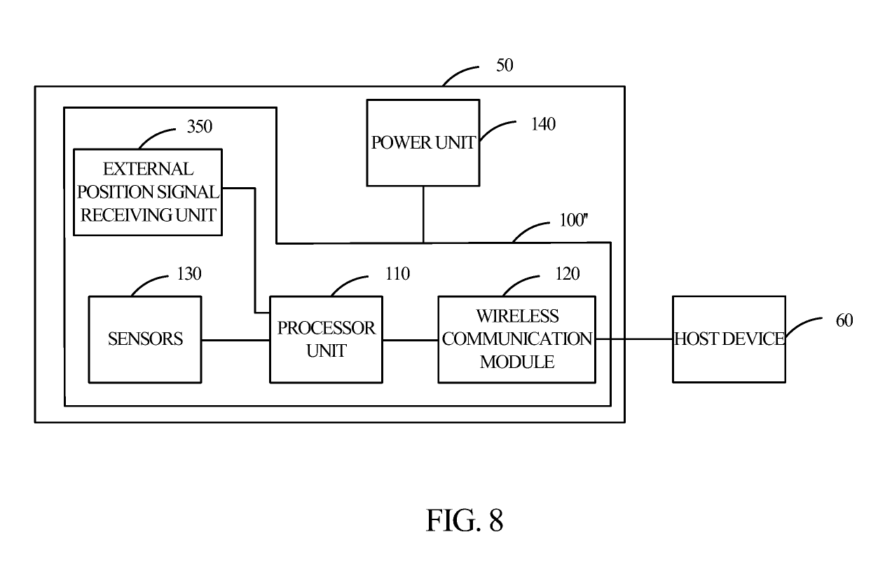

Please refer to FIG. 8. FIG. 8 shows a device 50 for integrating a position, an attitude, and a wireless transmission in accordance with a fifth embodiment of the present invention.

A difference between the present embodiment and the fourth embodiment is that the processor unit 110, the wireless communication module 120, the sensors 130, and the external position signal receiving unit 350 are packaged as a monolithic package structure on an electrical connection substrate 100″ in the device 50 for integrating the position, the attitude, and the wireless transmission of the present embodiment. In the present embodiment, since the processor unit 110, the wireless communication module 120, the sensors 130, and the external position signal receiving unit 350 are packaged as the monolithic package structure, the objective of miniaturization can be further achieved. The descriptions with respect to the device 50 for integrating the position, the attitude, and the wireless transmission of the present embodiment can refer to those of the first embodiment to the third embodiment and are not repeated herein.

The devices 10, 20, 30, 40, and 50 for integrating the position, the attitude, and the wireless transmission of the present invention can achieve an absolute position, and thus they can implement a relative position with a mobile terminal (e.g. a mobile phone). When the mobile phone is moved or rotated, the position of the devices 10, 20, 30, 40, and 50 for integrating the position, the attitude, and the wireless transmission relative to the mobile phone is fixed. As a result, the position of the devices 10, 20, 30, 40, and 50 for integrating the position, the attitude, and the wireless transmission of the present invention can be applied to a game in which an absolute position is required.

Furthermore, the devices 10, 20, 30, 40, and 50 for integrating the position, the attitude, and the wireless transmission of the present invention can be manufactured as a miniaturization device, and thus they can be applied to a wearable device, for example, a somatosensory bracelet.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A device for integrating a position, an attitude, and a wireless transmission, comprising:
an electrical connection substrate;
a processor unit;
a wireless communication module electrically coupled to the processor unit via the electrical connection substrate; and
a set of sensors electrically coupled to the processor unit and comprising a group of accelerometer sensors, a group of angular velocity sensors, and a group of magnetic sensors,
wherein the accelerometer sensors are utilized for sensing acceleration values of at least three directions, the angular velocity sensors are utilized for sensing angular velocity values of the at least three directions, and the magnetic sensors are utilized for sensing magnetic values of the at least three directions,
the processor unit receives the acceleration values of the accelerometer sensors, the angular velocity values of the angular velocity sensors, and the magnetic values of the magnetic sensors and calculates a position and an attitude value in a space according to the acceleration values of the accelerometer sensors, the angular velocity values of the angular velocity sensors, and the magnetic values of the magnetic sensors,
the processor unit and the wireless communication module are packaged as a monolithic package structure on the electrical connection substrate.

2. The device for integrating the position, the attitude, and the wireless transmission according to claim 1, wherein a thickness of the electrical connection substrate is smaller than 100 micrometers.

3. The device for integrating the position, the attitude, and the wireless transmission according to claim 1, wherein the electrical connection substrate is a flexible multi-layer substrate.

4. The device for integrating the position, the attitude, and the wireless transmission according to claim 3, wherein the electrical connection substrate comprises a plurality of metal layers and a plurality of dielectric layers which are alternately formed.

5. The device for integrating the position, the attitude, and the wireless transmission according to claim 4, wherein the dielectric layers are formed by same material.

6. The device for integrating the position, the attitude, and the wireless transmission according to claim 1, wherein the processor unit, the wireless communication module, and the sensors are packaged as the monolithic package structure on the electrical connection substrate.

7. The device for integrating the position, the attitude, and the wireless transmission according to claim 1, further comprising an external position signal receiving unit electrically coupled to the processor unit for positioning the device for integrating the position, the attitude, and the wireless transmission.

8. The device for integrating the position, the attitude, and the wireless transmission according to claim 7, wherein the sensors and the external position signal receiving unit are packaged as a monolithic package structure on another one electrical connection substrate.

9. The device for integrating the position, the attitude, and the wireless transmission according to claim 7, wherein the processor unit, the wireless communication module, the sensors, and the external position signal receiving unit are packaged as the monolithic package structure on the electrical connection substrate.

10. The device for integrating the position, the attitude, and the wireless transmission according to claim 1, further comprising a power unit electrically coupled to the electrical connection substrate, wherein the power unit is utilized for providing required power for the processor unit and the wireless communication module.

11. The device for integrating the position, the attitude, and the wireless transmission according to claim 1, electrically coupled to a host device, wherein the wireless communication module transmits the position and the attitude value in the space which are calculated by the processor unit.

12. A device for integrating a position, an attitude, and a wireless transmission, comprising:
a first electrical connection substrate;
a processor unit;
a wireless communication module electrically coupled to the processor unit via the first electrical connection substrate;
the processor unit and the wireless communication module packaged as a monolithic package structure on the first electrical connection substrate;
a second electrical connection substrate; and
a set of sensors electrically coupled to monolithic package structure via the second electrical connection substrate, and the sensors comprising a group of accelerometer sensors, a group of angular velocity sensors, and a group of magnetic sensors,
wherein the accelerometer sensors are utilized for sensing acceleration values of at least three directions, the angular velocity sensors are utilized for sensing angular velocity values of the at least three directions, and the magnetic sensors are utilized for sensing magnetic values of the at least three directions,
the processor unit receives the acceleration values of the accelerometer sensors, the angular velocity values of the angular velocity sensors, and the magnetic values of the magnetic sensors and calculates a position and an attitude value in a space according to the acceleration values of the accelerometer sensors, the angular velocity values of the angular velocity sensors, and the magnetic values of the magnetic sensors.

13. The device for integrating the position, the attitude, and the wireless transmission according to claim 12, wherein a thickness of the first electrical connection substrate is smaller than 100 micrometers.

14. The device for integrating the position, the attitude, and the wireless transmission according to claim 12, wherein the first electrical connection substrate is a flexible multi-layer substrate.

15. The device for integrating the position, the attitude, and the wireless transmission according to claim 14, wherein the electrical connection substrate comprises a plurality of metal layers and a plurality of dielectric layers which are alternately formed.

16. The device for integrating the position, the attitude, and the wireless transmission according to claim 15, wherein the dielectric layers are formed by same material.

17. The device for integrating the position, the attitude, and the wireless transmission according to claim 12, further comprising an external position signal receiving unit electrically coupled to the processor unit for positioning the device for integrating the position, the attitude, and the wireless transmission.

18. The device for integrating the position, the attitude, and the wireless transmission according to claim 12, further comprising a power unit electrically coupled to the electrical connection substrate, wherein the power unit is utilized for providing required power for the processor unit and the wireless communication module.

19. The device for integrating the position, the attitude, and the wireless transmission according to claim 12, electrically coupled to a host device, wherein the wireless communication module transmits the position and the attitude value in the space which are calculated by the processor unit.
